(19) United States
(12) Patent Application Publication
(10) Pub. No.: US 2003/0155748 A1
(43) Pub. Date: Aug. 21, 2003

(54) Modular trailer system

(76) Inventors: Claude Picard, Plymouth, MN (US); Dave Larson, Plymouth, MN (US); Dan Braegelman, Plymouth, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/322,372

(22) Filed: Dec. 17, 2002

Related U.S. Application Data
(60) Provisional application No. 60/341,502, filed on Dec. 17, 2001.

(51) Int. Cl. B62B 1/00

(52) U.S. Cl. 280/656

(57) ABSTRACT

The modular trailer of the present invention generally includes a base frame, a tire assembly, a tongue assembly, an end assembly and at least one modular carrier assembly. The modular carrier assembly is available in a plurality of configurations and can be used for transporting vehicles such as personal watercraft, all terrain vehicles, motorcycles, bicycles, golf carts and lawn and garden equipment. The modular carrier assemblies are removably securable to the base frame assembly to provide a myriad of structural and functional configurations for the trailer system. Each carrier assembly is fully compatible with the base frame and designed for ease-of-use and installation. Modular engagement of the carrier assembly to the base frame assembly is generally achieved using channeling frame members and fasteners and securing means capable of engagement and securement substantially without the use of tools. Additionally, the collapsible features of the adjustable portions of the base frame provide significant storability benefits.

### PRIORITY

The present invention claims priority to Provisional Application No. 60/341,502 filed Dec. 17, 2001, entitled MODULAR TRAILER SYSTEM and is incorporated by reference herein.

### FIELD OF THE INVENTION

The present invention relates generally to trailers, and more particularly to trailers capable of accepting a plurality of modular assemblies to substantially alter the design and use of the trailer while also allowing for collapsibility and storability.

### BACKGROUND OF THE INVENTION

Various configurations for sport and utility trailers have become commonplace. These trailers are generally referred to as small utility trailers. Conventional practice is to manufacture a trailer that is designed for use in one specific area. For instance, trailers are commonly manufactured to transport boats, snowmobiles, motorcycles, bicycles, All Terrain Vehicles (ATV's), Personal Watercraft (PWC's), canoes, kayaks, golf carts, lawn and garden equipment and other recreational or maintenance equipment. In addition, trailers are often designed around transporting non-sport related equipment, materials, and goods. Trailers having small bed walls are often used for holding cargo such as tools, lumber, furniture, gravel, and the like.

The most significant drawback of the aforementioned trailers is that each one is designed for a single, narrow application. Consequently, an individual is typically required to purchase a separate trailer for each application. At the most, attempts are made to utilize flatbed trailers for two or three various applications. For instance, an end user may use it to haul cargo, and to transport ATVs or other more stable vehicles. However, since these flatbed trailers do not take into account the intricacies of popular trailered vehicles such as PWC's and motorcycles, features such as stability, security, safety, and convenience fall by the wayside. As a result, end users are faced with the costly purchase of multiple trailers. In addition to the initial purchase price for the multiplicity of trailers, the storage and maintenance costs associated with owning multiple trailers increases the financial burden and overall inconvenience.

In addition to the singular focus of conventional trailers, the overall design of these trailers are significantly flawed. Traditional designs are cumbersome, difficult to handle, and difficult to store. Consequently, trailers are primarily purchased and utilized by those willing to tolerate the inconveniences, and to those willing to spend the time and effort required to fully understand and use their trailers. This creates a barrier to popular acceptance of these conventional trailers.

Even those that choose to use specialized conventional trailers do not need to have the trailers out and ready for use at all times. Conventional designs do not promote ease of storage. This is especially troublesome for those end users having multiple trailers.

So while outdoor activities are becoming more popular and the purchase and use of recreational vehicles is becoming more common, the transporting of such vehicles has progressed minimally over time. As a result, there is a need for a trailer system that substantially solves the above problems present with conventional trailer designs.

### SUMMARY OF THE INVENTION

The present invention solves many of the problems that plague conventional trailer units by providing for a modular trailer system. The embodiments of the present invention are directed to a single modular trailer capable of being configured for use in trailering and storing a variety of different vehicles. The modular trailer is also configurable to transport or store a plurality of vehicles at the same time where the vehicles can be of the same or differing types. In addition, the trailer system in accordance with the present invention is designed for dramatically reducing the overall footprint required to store an unloaded modular trailer when not in use. With an improved modular trailer system (or a sport utility trailer—S.U.T.) such as the one disclosed, safety concerns such as load balancing, weight capacity and environmental factors are also addressed by providing proper compatibility between the transporting objects/vehicles and a correct modular assembly for the trailer.

The trailer system in accordance with the present invention can include a base assembly having a base frame, a tongue assembly, and a wheel assembly. In addition, a variety of modular assemblies, also known as kits, are removably securable to the base frame assembly to provide a myriad of structural and functional configurations for the trailer system. Each modular assembly or kit is fully compatible with the base frame assembly, and designed for ease-of-use and installation. Modular engagement of the kits to the frame assembly is generally achieved using channeling frame members and fasteners capable of engagement and securement substantially without the use of tools. Alternatively, tools can be provided with each of the corresponding modular assembly kits.

### BRIEF DESCRIPTION OF THE DRAWINGS

FIG. 1 is a perspective view of a modular trailer.

FIG. 2 is a perspective view of a modular trailer.

FIG. 3 is a perspective view of a base frame for a modular trailer.

FIG. 4 is a perspective view of an end assembly for a modular trailer

FIG. 5 is a perspective view of a tongue assembly for a modular trailer.

FIG. 6 is a perspective view of an embodiment of a carrier assembly for a modular trailer.

FIG. 7 is a perspective view of an embodiment of a mounting channel for a modular trailer.

FIG. 8 is a perspective view of an embodiment of a mounting channel for a modular trailer.

FIG. 9 is an end view of an embodiment of a mounting channel for a modular trailer.

FIG. 10 is a side view of an embodiment of a carrier assembly for a modular trailer.

FIG. 11 is an end view of a tire channel for the carrier assembly of FIG. 10.

FIG. 12 is a perspective view of an embodiment of a carrier assembly for a modular trailer.

FIG. 13 is a side view of the carrier assembly of FIG. 12.

FIG. 14 is an end view of the carrier assembly of FIG. 13.

FIG. 15 is a side view of the modular trailer with a PWC carrier assembly.

FIG. 16 is a perspective view of a PWC front support.

FIG. 17 is a side view of a winch support.

FIG. 18 is a perspective view of the winch support of FIG. 16.

FIG. 19 is a top view of the winch support of FIG. 16.

FIG. 20 is a side view of a roller mount.

FIG. 21 is a side view of the modular trailer in a vertical storage position.

### DETAILED DESCRIPTION OF THE PREFERRED EMBODIMENTS

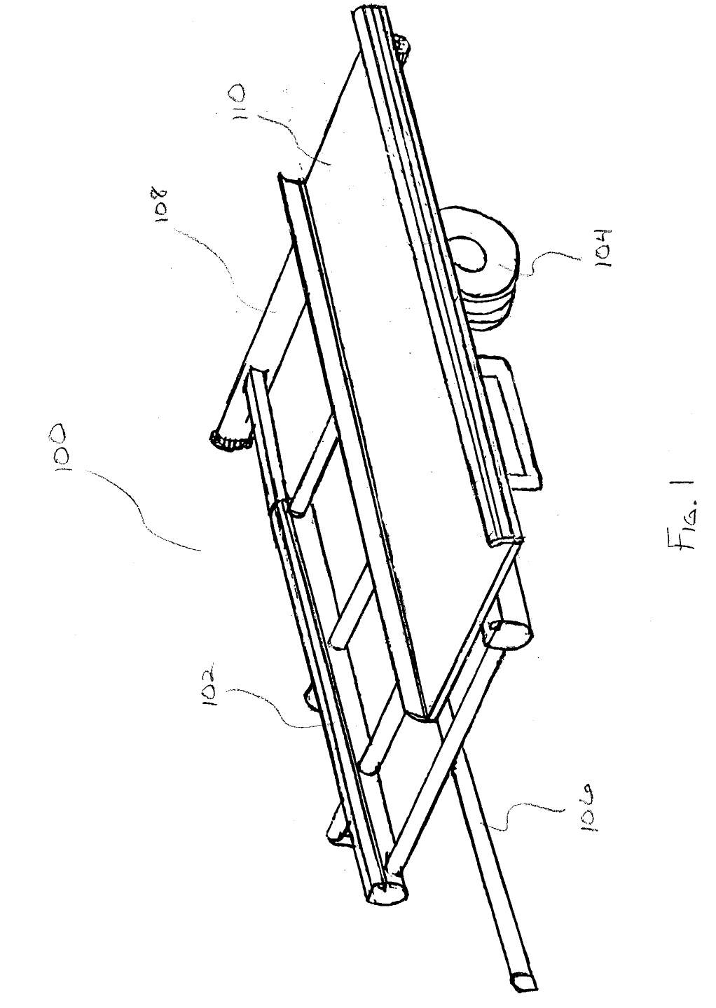

An embodiment of a modular trailer 100 is depicted in FIG. 1. In its most general configuration, trailer 100 includes a base frame 102, a tire assembly 104, a tongue assembly 106, an end assembly 108 and a carrier assembly 110. In a preferred embodiment, base frame 102, end assembly 108 and carrier assembly 110 are manufactured of aluminum to reduce the overall weight of trailer 100, while tongue assembly 106, is made out of steel for better stiffness. While aluminum is a preferred material due to its low cost, high strength and its corrosion resistance, other materials exhibiting the same properties could be used as well. Examples of such materials include various plastic polymers, composite materials and other lightweight metals.

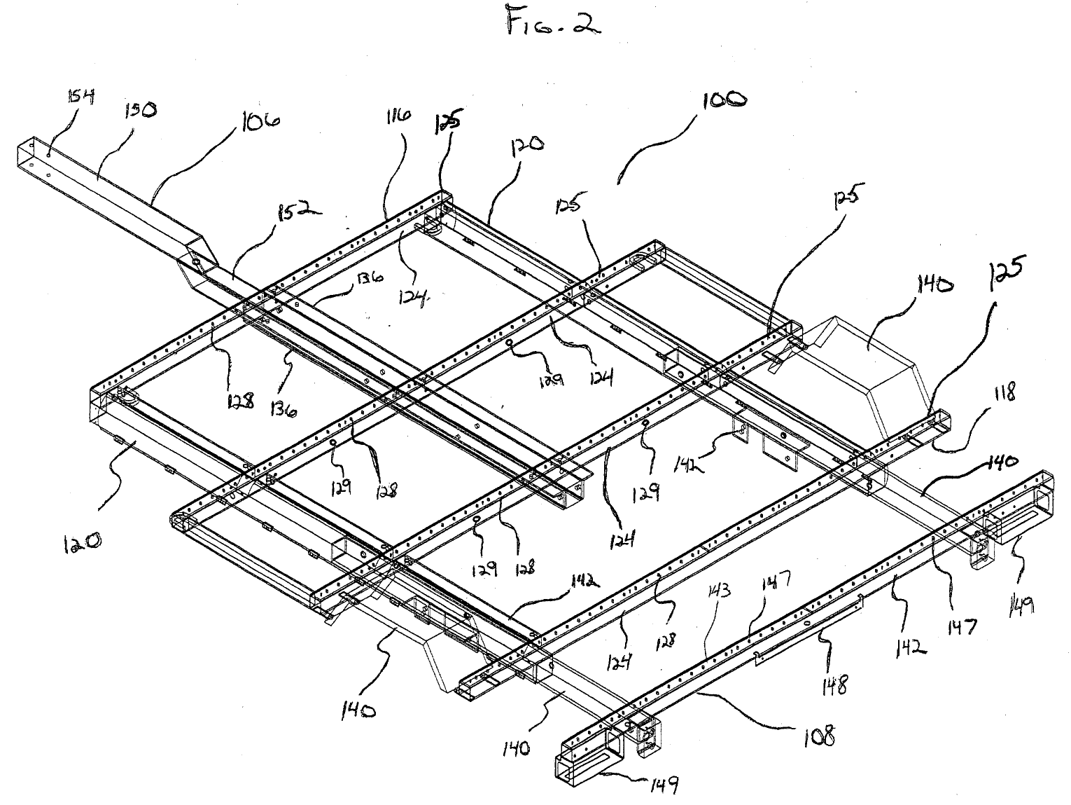

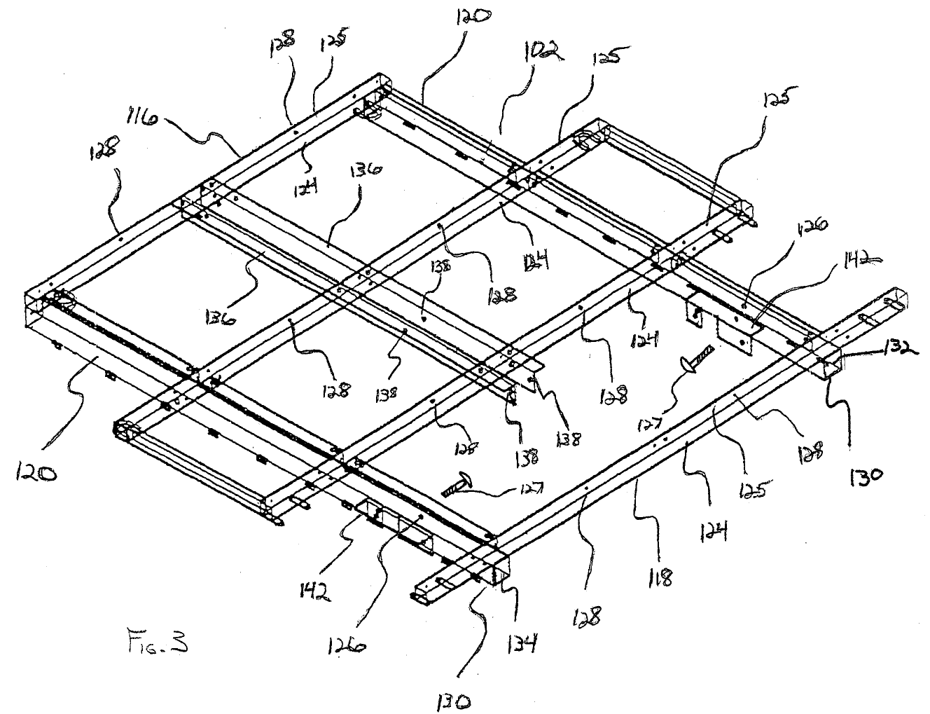

Referring to FIGS. 2-3, base frame 102 is defined by a front end 116, a rear end 118 and a pair of side members 120. Side members 120 are linked by a plurality of cross members 124 that lie in a transverse orientation to side members 120. Side member 120 is a generally hollow member including a series of side member throughbores 126. In a preferred embodiment, side member throughbores 126 lie in a horizontal plane. Alternatively, side member throughbores 126 can have a vertical orientation. Side member throughbores 126 are dimensioned to accommodate a side member fastener 127. Most preferably, side member fastener 127 is a screw type fastener including a head design suitable for hand tightening and loosening. Alternatively, side member fastener 127 can be of a spring loaded pin design. Cross member 124 is a generally hollow member onto which a cross member plate 125 is attached, preferably welded. Cross member plate 125 is preferably a zinc plated steel plate including a series of cross member top bores 128 that lie in a vertical plane. Two of the cross members 124 include three cross member horizontal throughbores 129. Side member 120 also includes an open end 130 at the rear end 118 of base frame 102. Open end 130 provides access to a hollow interior 132 having a side member interior cross-section 134. Base frame 102 also includes a pair of connecting angles 136 located proximate to the center of front end 116 and mounted transversely to the cross members 124. Connecting angles 136 include a series of angle throughbores 138. The pair of connecting angles 136 are positioned and mounted to accommodate the tongue assembly 106. In addition, connecting angles 136 are mounted such that corresponding angle throughbores 138 are in horizontal alignment. Base frame 102 also includes a pair of wheel wells 140 and a pair of axle brackets 142. In a preferred embodiment, base frame 102 is of welded construction. Alternatively, fasteners such as nuts and bolts can be used in assembling base frame 102.

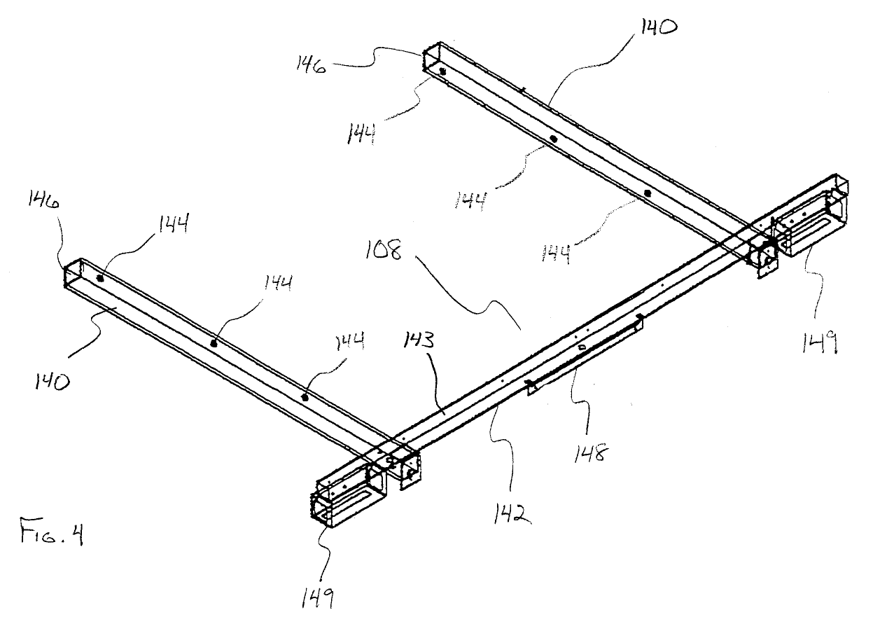

Referring to FIG. 2 and FIG. 4, end assembly 108 includes a pair of insertion members 140 and an end member 142. Insertion member 140 includes a series of insertion throughbores 144 that correspond to the orientation and spacing of side member throughbores 126. Most preferably, insertion throughbores 144 are threaded to accommodate side member fastener 127. Insertion member 140 is a generally hollow member having an exterior cross-section 146. Insertion member 140 is selected such that exterior cross-section 146 will slidably insert into side member interior cross-section 134. End member 142 also includes an end plate 143 having a series of end member top bores 147, a license plate bracket 148 and a pair of rear trailer lights 149.

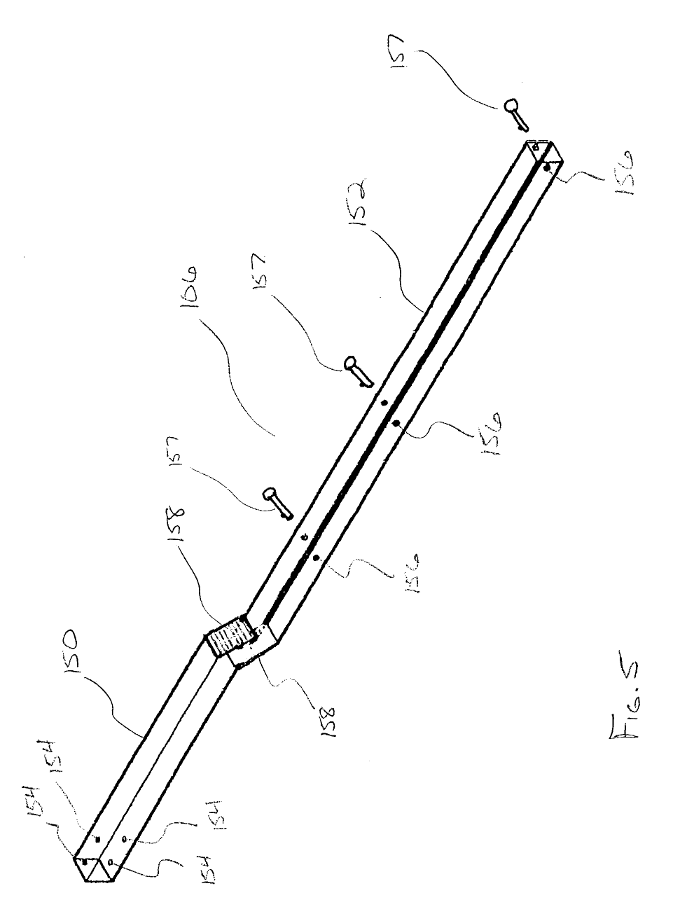

Referring to FIG. 2 and FIG. 5, tongue assembly 106 includes a first tongue member 150 and a second tongue member 152. Both first tongue member 150 and second tongue member 152 have a generally hollow configuration and are preferably welded together. First tongue member 150 includes a plurality of hitch throughbores 154 for mounting a commercially available hitch coupler (not shown). Second tongue member 152 includes a series of tongue throughbores 156 corresponding to the spacing and orientation of angle throughbores 138. A plurality of tongue fasteners 157 are dimensioned to insert through tongue throughbores 156 and angle throughbores 138. Preferably, tongue fasteners 157 are of a spring loaded pin design. Alternatively, tongue fasteners could include nuts and bolts or other appropriate fastener designs. Second tongue member 152 is dimensioned such that it fits snugly between connecting angles 136. Tongue assembly 106 also includes a pair of end caps 158.

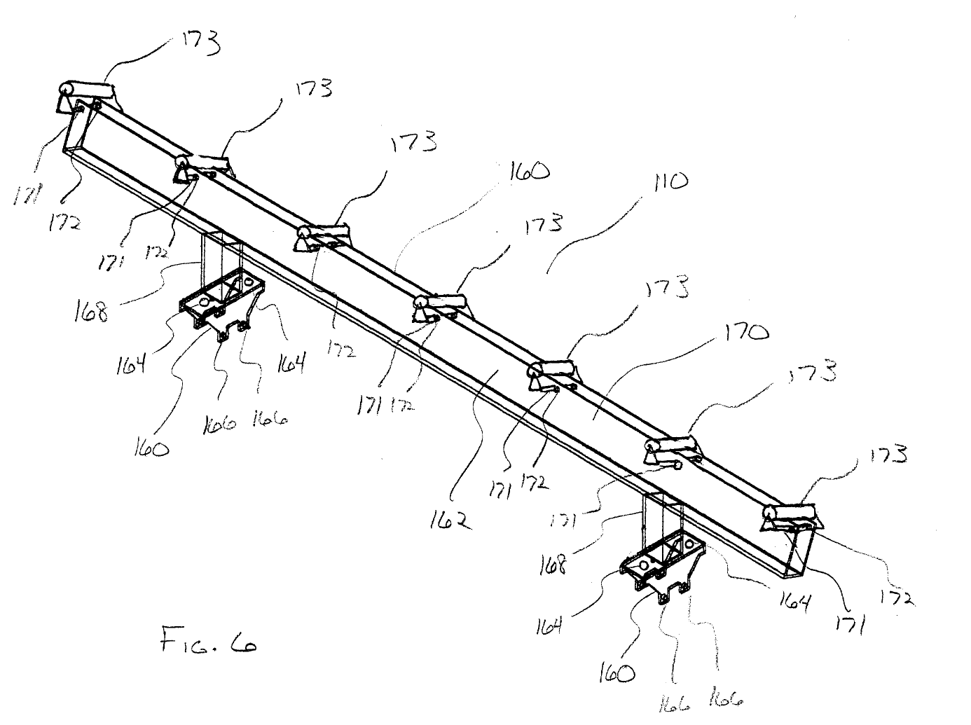

Referring to FIG. 6, carrier assembly 110 is described generally with reference to a PWC support bunk 159 for ease of description. Carrier assembly 110 will generally include at least one mounting channel 160 and at least one support member 162. Mounting channel 160 and support member 162 are preferably welded to form carrier assembly 110 but a variety of fasteners could also be employed. Mounting channel 160 includes at least one vertical projection 164 and at least one horizontal channel throughbore 166. Vertical projection 164 is preferably press-fit into mounting channel 160 but could also be welded. Specific to PWC support bunk 159, a pair of support extensions 168 connect the pair of mounting channels and a PWC member 170. PWC member 170 has a generally hollow configuration and includes a plurality of PWC member throughbores 172. PWC member throughbores 172 are meant to accommodate a series of roller assemblies 173 that are individually fastened with a series of bunk fasteners 171. Alternatively, a protective cover or sheet can be used in place of roller assemblies 173.

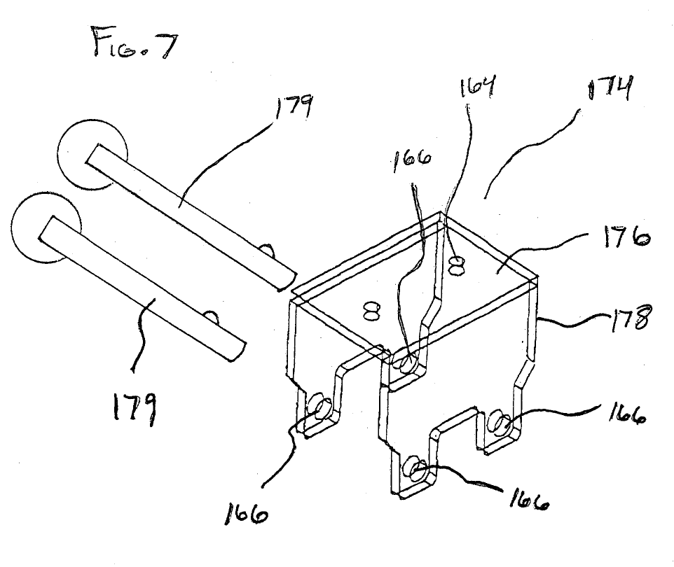

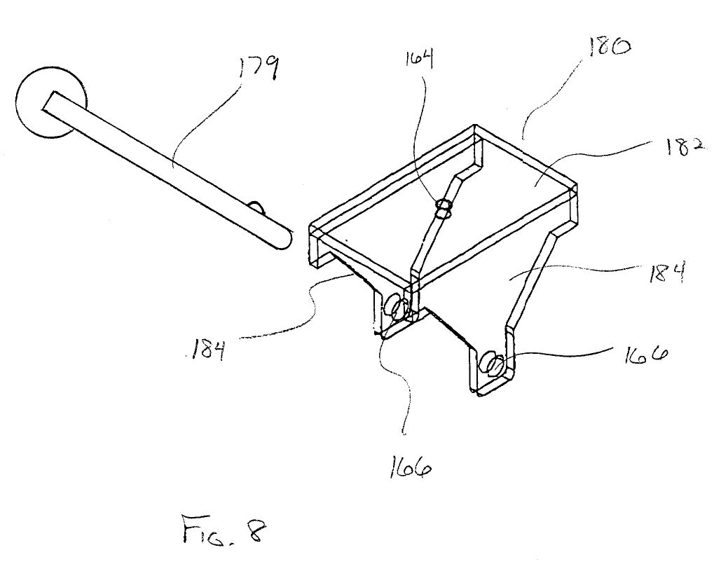

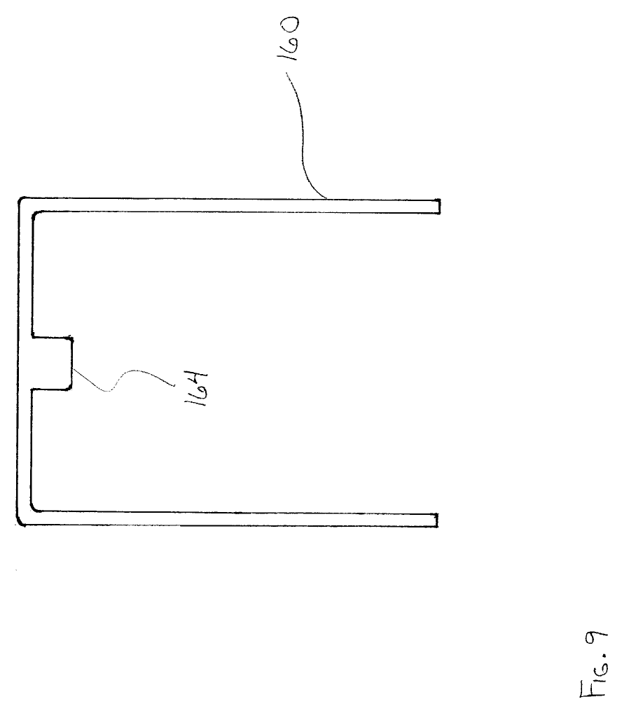

Referring to FIGS. 7-9, two embodiments of mounting channel 160 are depicted. A dual bore mounting channel 174 is comprised of a dual top plate 176 and a pair of dual side plates 178. Dual bore mounting channel 174 is configured such that it can be placed over cross members 124 with the dual top plate 176 and the dual side plates 178 in intimate contact with the exterior of cross member 124. Dual top plate 176 includes a pair of vertical projections 164 positioned to align with a pair of cross member top bores 128 or end member top bores 147. Each dual side plate 178 includes a pair of horizontal channel throughbores 166. The dual side plates 178 are affixed to the dual top plate 176 so that corresponding horizontal channel throughbores 166 are in horizontal alignment. A pair of channel fasteners 179 are fully inserted through the corresponding horizontal channel throughbores 166. Channel fasteners 179 are preferably of a spring loaded pin design. Alternatively, channel fasteners 179 fasteners can include nuts and bolts, fasteners with retainers, interference fit fasteners or other appropriate fastener designs. In yet another embodiment, channel fasteners 179 can include a single bracket having a pair of mounting ends dimensioned to simultaneously insert into the horizontal channel throughbores 166.

A second embodiment of mounting channel 160 includes a single bore-mounting channel 180. A single bore-mounting channel 180 is comprised of a single top plate 182 and a pair of single side plates 184. Single bore mounting channel 180 is configured such that it can be placed over cross members 124 with the single top plate 182 and the single side plates 184 in intimate contact with the exterior of cross member 124. Single top plate 182 includes vertical projection 164 positioned to align with cross member top bores 128 or end member top bores 147. Each single side plate 184 includes a horizontal channel throughbore 166. The single side plates 184 are affixed to the single top plate 182 so that corresponding horizontal channel throughbores 166 are in horizontal alignment. A single channel fastener 179 is then fully inserted through the horizontal channel throughbores 166. While two embodiments of mounting channel 160 have been disclosed, numerous other embodiments are contemplated whereby the number of vertical projections 164 and horizontal channel throughbores 166 could be altered without departing from the spirit of the present invention.

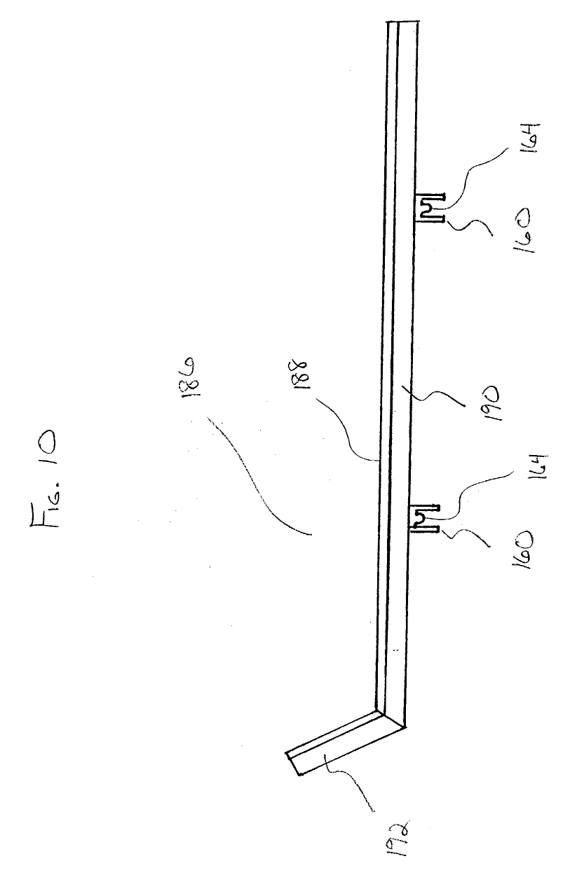

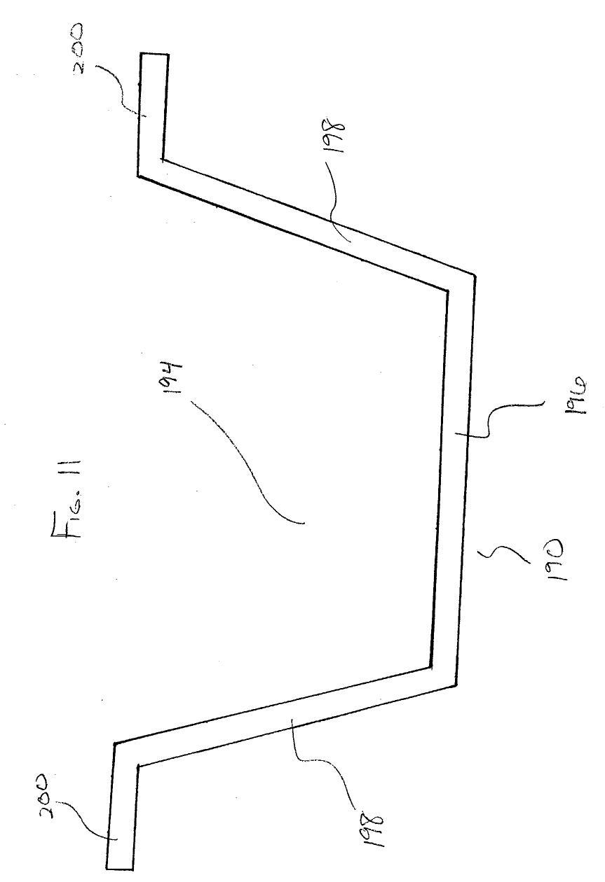

FIGS. 10-11 contain a depiction of an embodiment of carrier assembly 110, hereafter referred to as bike carrier 186, configured for carrying motorcycles and bicycles in an upright position. Bike carrier 186 includes a tire channel 188 and a pair of mounting channels 160. It is specifically contemplated that additional mounting channels 160 could be included as part of bike carrier 186. It is also specifically contemplated that mounting channels 160 could take the form of either single bore mounting channel 180 or dual bore mounting channel 174. Most preferably, mounting channels 160 are welded to tire channel 188 however various fastener systems could also be employed.

Tire channel 188 is preferably comprised of aluminum and includes a first bike member 190 and a second bike member 192. Tire channel 188 includes a tire cross-section 194 defined by a tire floor 196 and a pair of tapered tire walls 198. Tire channel 188 may also include a pair of tire top surfaces 200.

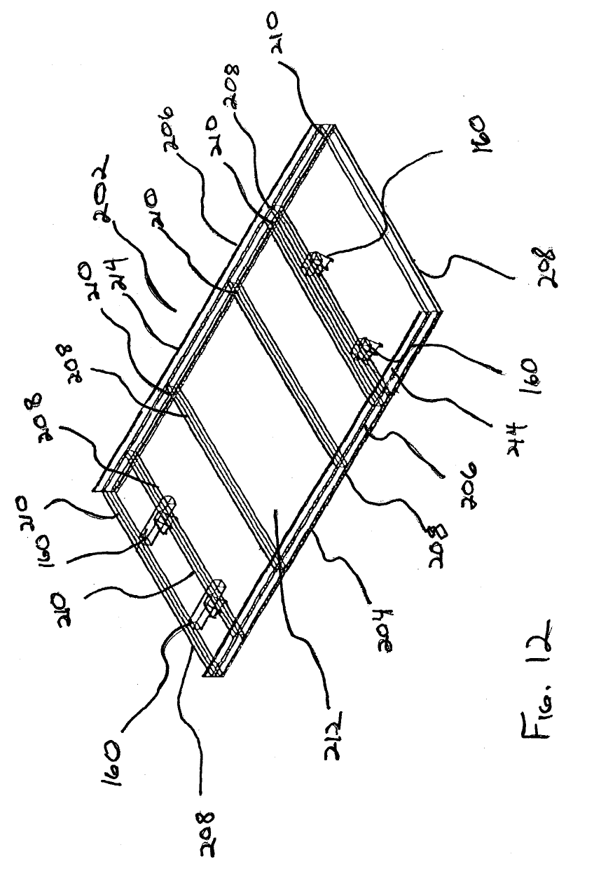

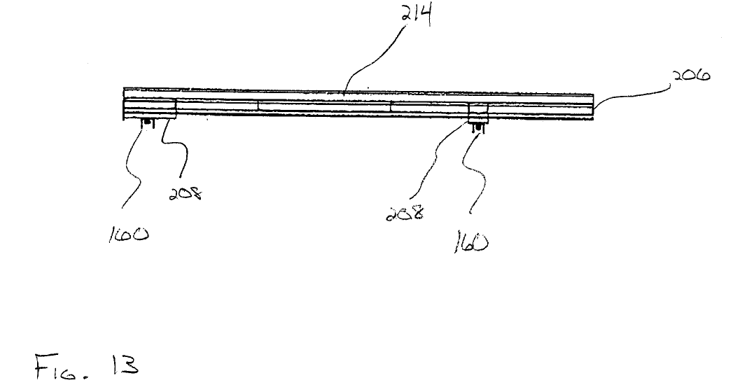

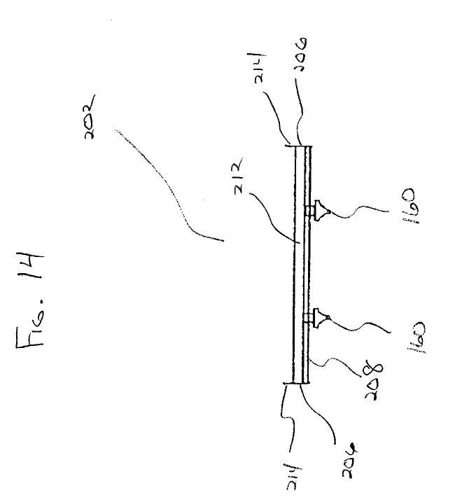

FIGS. 12-14 contain a depiction of a carrier assembly 110, hereafter referred to as ATV carrier 202 configured for carrying ATV's, snowmobiles, golf carts, lawn and garden equipment and other vehicles in which a flat carrying surface is desired. ATV carrier 202 or similar flat carrying surface can be used as a utility bed for transporting a myriad of items such as tools, lumber, furniture, gravel and the like. ATV carrier 202 includes a carrier frame 204 comprising a pair of carrier side members 206 and a plurality of carrier cross members 208. ATV carrier 202 also includes a plurality of mounting channels 160 supporting the carrier cross members 208. It is specifically contemplated that mounting channels 160 could take the form of either single bore mounting channel 180 or dual bore mounting channel 174. While ATV carrier 202 is depicted having four mounting channels 160, it is specifically contemplated that additional mounting channels 160 could be included and the mounting positions on carrier cross members 206 could be adjusted. Fixedly attached to a top mounting surface 210 on carrier cross members 208 is a floor member 212. Floor member 212 has a generally flat cross-section and is preferably made of treated plywood. Alternatively, floor member 212 can be made of plastic or composite materials. Alternatively, floor member 212 can include tracks, recesses or other grip enhancing surfaces. Each carrier side member 206 includes a projecting end 214 extending above floor member 212.

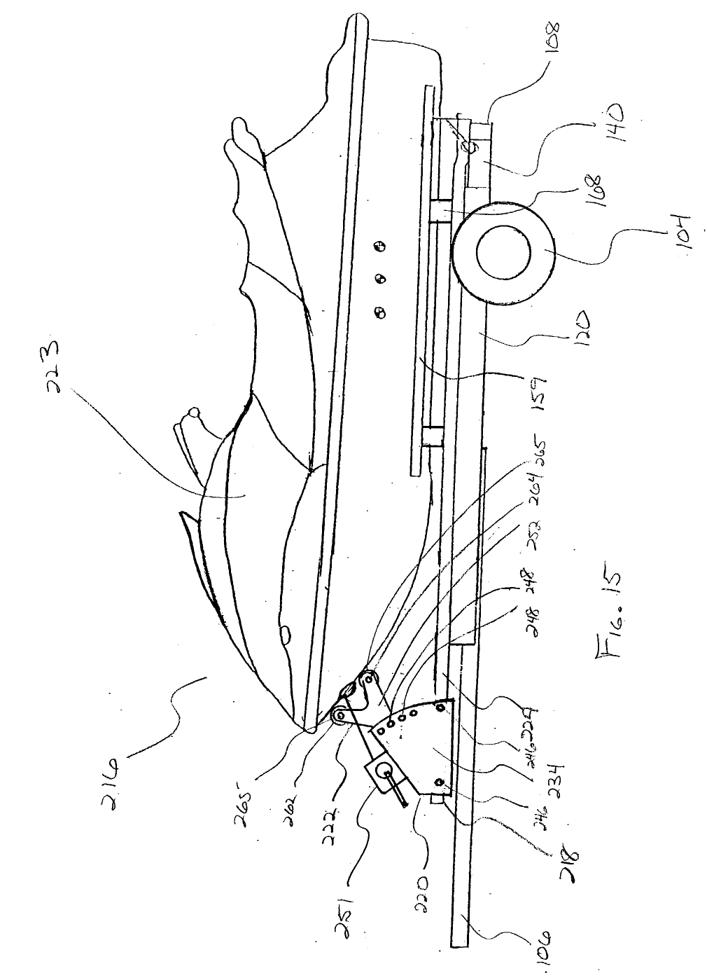

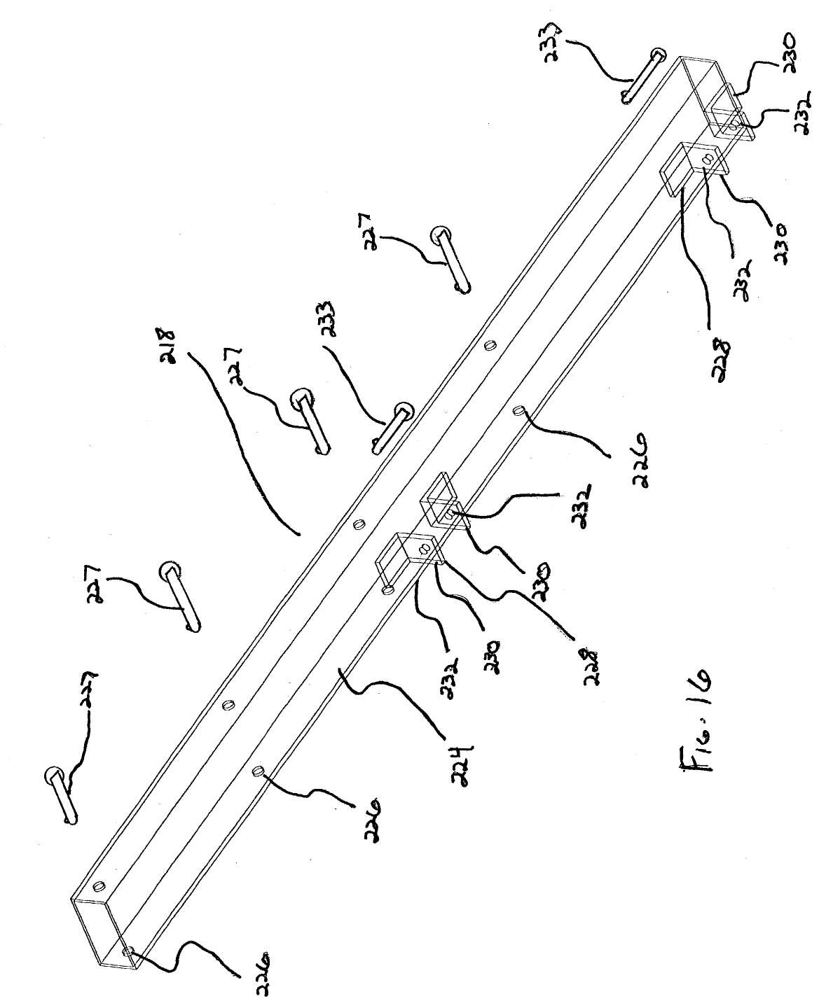

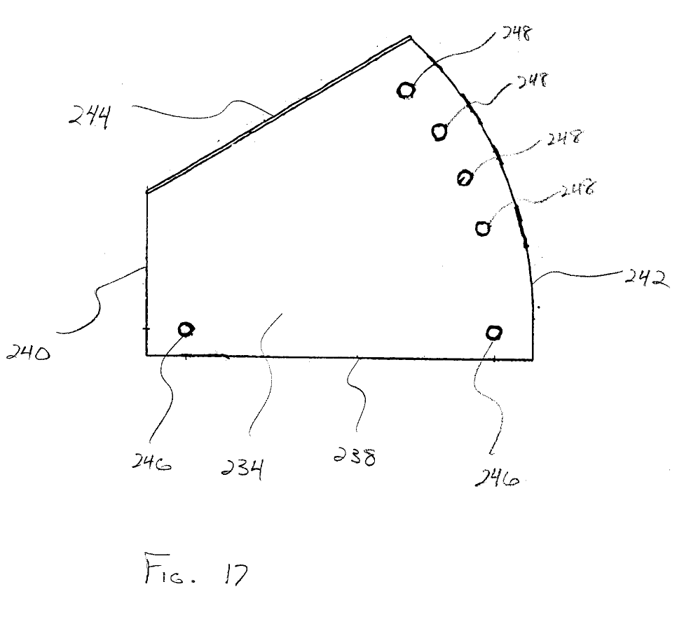

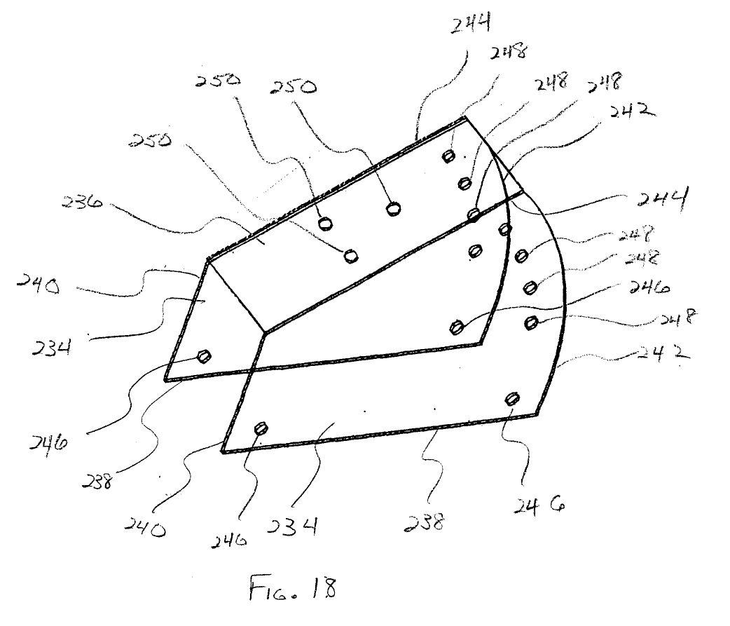

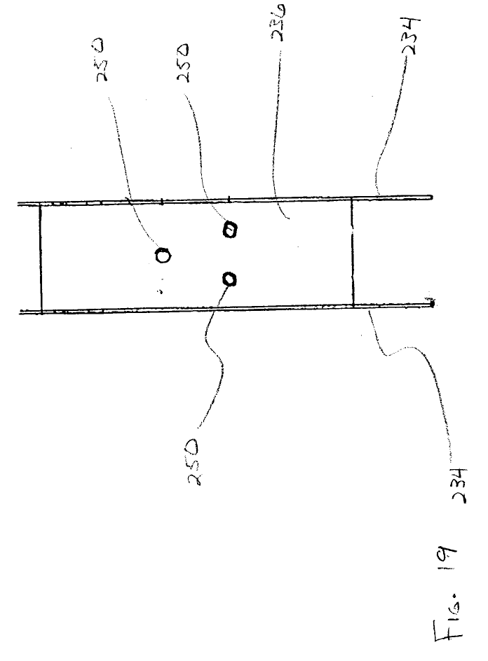

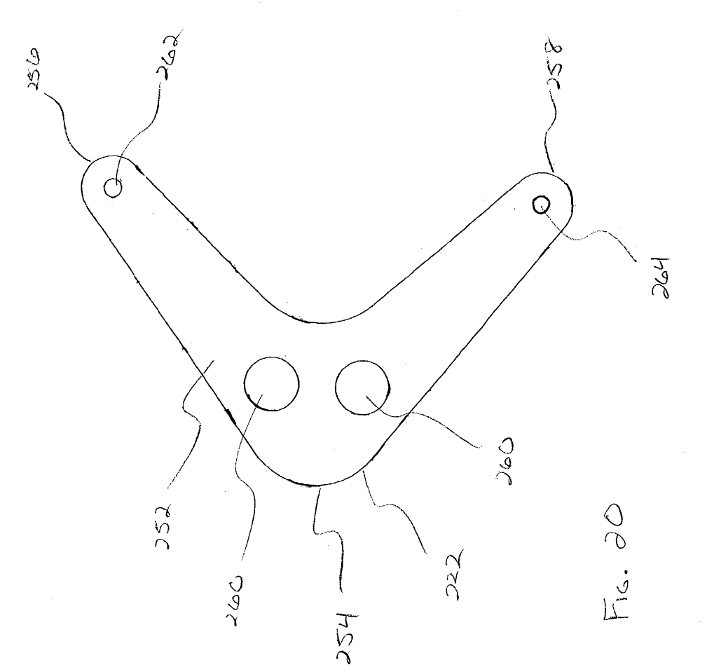

FIGS. 15-20 in combination with FIG. 6 contain a depiction of a carrier assembly 110, hereafter referred to as PWC carrier 216. PWC carrier 216 includes a pair of PWC support bunks 159, a PWC front support 218, a winch mount 220 and a front roller mount 222. A PWC 223 is depicted as residing on PWC support bunks 159. Alternatively, canoes and kayaks could be used in conjunction with PWC carrier 216. PWC front support 218 is a generally hollow member including a front support member 224 having a series of front support throughbores 226 and a pair of mounting brackets 228. A plurality of support fasteners 227 are dimensioned to fully insert through front support throughbores 226. Preferably, support fasteners 227 are spring loaded pin fasteners but other fasteners such as nut and bolt, retainer clips and other fastener configurations could be employed. Each mounting bracket 228 consists of a pair of mounting angles 230 having angle bores 232. A pair of angle fasteners 233 are dimensioned to fully insert through angle bores 232. Preferably, angle fasteners 233 are spring loaded pin fasteners but other fasteners such as nut and bolt, retainer clip and other fastener configurations could be employed. Preferably, mounting angles 230 are welded to PWC front support 218. Winch mount 220 includes a pair of corresponding side plates 234 welded to a top plate 236. Side plate 234 is defined by a bottom surface 238, a front surface 240, a radial surface 242 and a top angled surface 244. Each side plate 234 includes a pair of support bores 246 and a series of radial bores 248. Top plate 236 includes a series of winch bores 250 for mounting a winch 251. Front roller mount 222 includes a pair of mounting plates 252 with a v-shaped configuration. Each mounting plate 252 has a front mounting end 254, a top mounting end 256 and a bottom mounting end 258. Each mounting plate 252 includes a pair of front mounting bores 260, a top mounting bore 262 and a bottom mounting bore 264. Affixed mounting plates 252 using top mounting bores 262 and bottom mounting bores 264 are a pair of rollers 265.

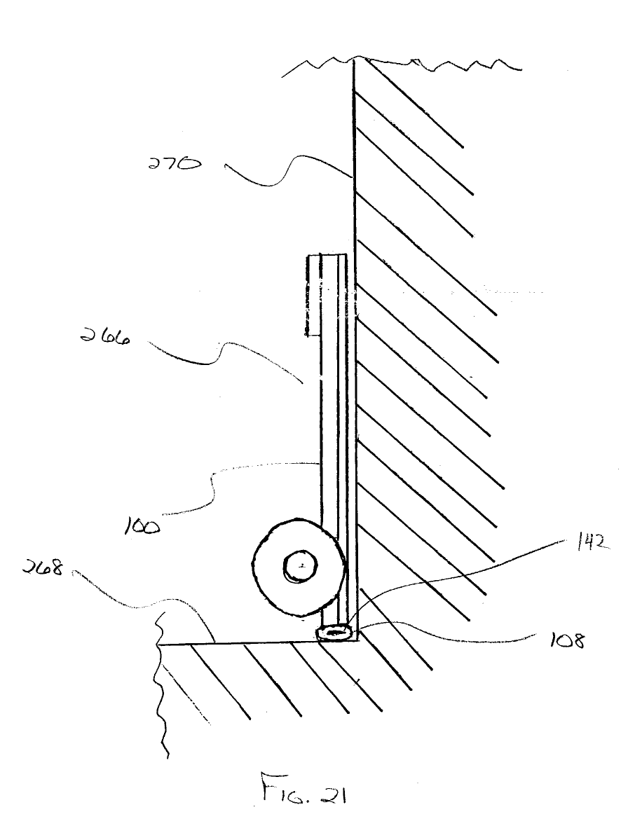

FIG. 21 depicts trailer 100 in a vertical storage position 266. Trailer 100 rests on end assembly 108 which is in contact with a floor surface 268. Trailer 100 is shown next to a wall surface 270.

In actual use, trailer 100 is assembled by interconnecting the base frame 102 with the tire assembly 104, tongue assembly 106, end assembly 108 and at least one carrier assembly 110. First, tire assembly 104 is mounted to the axle brackets 142, most preferably using a torsion suspension axle assembly or a set of leaf springs on tire assembly 104. Next, the tongue assembly 106 is positioned so that the second tongue member 152 resides within the connecting angles 136. The tongue throughbores 156 are aligned with the angle throughbores 138 and tongue fasteners 157 are fully inserted through the connecting angles 136 and the second tongue member 152 resulting in the tongue assembly 106 being affixed to base frame 102. The positioning of tongue throughbores 156 and angle throughbores 138 allow tongue assembly 106 to be installed in two distinct locations. The end assembly 108 is then positioned so that insertion members 140 are near to and in alignment with the open ends 130 on side members 120. The insertion members 140 are inserted a desired length into the open ends 130 such that at least one of the side member throughbores 126 is in alignment with at least one of the insertion member throughbores 144 on both sides of base frame 102. Side member fastener 127 is then inserted and preferably screwed through the side member throughbores 126 and insertion member throughbores 144 causing the end assembly 108 to be affixed to the base frame 102. Finally, the user will select one or more carrier assemblies 110 appropriate for the vehicles to be trailered. Carrier assembly 110 can consist of bike carrier 186, ATV carrier 202 or PWC carrier 216 or any combination thereof. Carrier assembly 110 is lifted into position such that mounting channel 160 is placed over the appropriate cross member 124 such that vertical projection 164 is inserted into cross member top bore 128. Mounting channel 160 can take the form of either single bore mounting channel 180 or dual bore mounting channel 174. The interaction of vertical projection 164 and cross member top bore 128 prevents mounting channel 160 from sliding on cross member 124. Channel fasteners 179 are slidably inserted through horizontal channel throughbores 166. The combination of channel fasteners 179 and the horizontal channel throughbores 166 result in the capture of cross member 124. Thus, carrier assembly 110 can no longer be lifted from cross member 124. This procedure is repeated for each mounting channel 160 on carrier assembly 110.

More specifically, bike carrier 186 is attached to trailer 100 such that second bike member 192 is proximate front end 116. First bike member 190 is positioned so that the vertical projections 164 on mounting channels 160 insert into cross member top bores 128 on cross members 124. Channel fastener 179 is then slidably inserted through horizontal channel throughbores 166 preventing mounting channel 160 from lifting off cross member 124. Once bike carrier 186 is affixed to trailer 100, a bike or motorcycle (not shown) can be loaded. The tires of the bike or motorcycle are positioned so that they reside within tire cross-section 194 of first bike member 190. The bike or motorcycle is pushed forward in first bike member 190 until the front tire resides within second bike member 192. Securing cords, ratcheting straps or other securing means can then be attached from the bike or motorcycle to base frame 102 to keep the bike or motorcycle in an upright position during transport.

Referring to ATV carrier 202, carrier frame 212 is positioned so that the vertical projections 164 on mounting channels 160 insert into cross member top bores 128 on cross members 124. Channel fastener 179 is then slidably inserted through horizontal channel throughbores 166 preventing mounting channel 160 from lifting off cross member 124. Once ATV carrier 202 is affixed to base frame 102, a vehicle such as an ATV, snowmobile, golf card or lawn and garden equipment can be rolled onto floor member 212. Securing cords, ratcheting straps or other securing means can then be attached from the vehicle to trailer 100 to keep the vehicle from rolling or sliding off floor member 212 during transport. Projecting ends 214 serve to prevent the vehicle from sliding off the sides of trailer 100.

Referring to PWC carrier 202, the pair of PWC support bunks 159 are positioned so that the vertical projections 164 on mounting channels 160 insert into cross member top bores 128 on cross members 124. Channel fastener 179 is then slidably inserted through horizontal channel throughbores 166 preventing mounting channel 160 from lifting off cross member 124. PWC front support 218 is positioned near the front end 116 of base frame 102 and centered between PWC support bunks 159 such that mounting brackets 228 fit over cross members 124. Angle fastener 233 is inserted through angle bores 232 and cross member horizontal throughbore 129 such that PWC front support 218 is fixedly attached to base frame 102. Winch mount 220 is positioned with front surfaces 240 facing front end 116. Winch mount 220 is placed over PWC front support 218 such that support bores 246 align with a pair of the front support throughbores 226. Support fastener 227 is inserted through the support bores 246 and front support throughbores 226 such that winch mount 220 is affixed to PWC front support 218. The pair of mounting plates 252 are positioned with the pair of side plates 234 such that the front mounting bores 260 align with two of the radial bores 248 and the top mounting bores 262 and bottom mounting bores 264 face the rear end 118. A fastener is inserted through the front mounting bores 260 and the radial bores 248 such that the mounting plates 252 are affixed to the winch mount 220. With respect to PWC carrier 216, it is possible to have either individual v-shaped rollers 265 or a v-shaped protective surface mounted between top mounting bores 262 and bottom mounting bores 264. The user will typically position trailer 100 such that the PWC 223 is centered between the PWC support bunks 159 with the front of PWC 223 facing the front end 116. The PWC 223 is pushed or winched forward with winch 251 such that the hull of the PWC 223 comes into contact with the roller assemblies 173 on the PWC support bunks 159. The PWC 223 is rolled forward until the front v-shape of the hull resides between the rollers 265 mounted between the top mounting bores 262 and bottom mounting bores 264. Securing cords, ratcheting straps or other securing means can then be attached from the PWC to trailer 100 to keep the PWC from rolling or sliding backwards off the PWC support bunks 159 during trailering.

When trailer 100 is not in use, the modular design allows a user to configure the trailer to occupy a minimum of storage space. In configuring the trailer 100 for storage, the user would first remove any carrier assemblies 110 mounted to the base frame 102. Carrier assemblies 110 are removed by removing the fasteners from the horizontal channel throughbores 166 on each mounting channel 160. The carrier assemblies 110 can then be lifted off of cross members 124.

Next, the user would fully insert the end assembly 108 into the base frame 102. The user would remove the fastener located within side member throughbores 126 and insertion throughbores 144. Once the fastener is removed, the user can slidably push on end member 142 such that the insertion members 140 slide into the side members 120. Insertion is completed when end member 142 comes into contact with open end 130 of side members 120.

Once the end assembly 142 has been inserted into the base frame 102, the user can remove the tongue assembly 106. The user removes the fasteners connecting tongue throughbores 156 with the angle throughbores 138. When the fasteners have been removed, second tongue member 152 is removed from between connecting angles 136 on base frame 102.

If the user desires to further reduce the space occupied trailer 100, the trailer can then be positioned in a vertical storage position 266. User would lift the front end 116 on base frame 102. Lifting of the front end 116 causes the end member 142 on end assembly 108 to come into contact with a floor surface 268. Further lifting of the front end 116 causes the tire assembly 104 to lift off the floor surface 268 and for the trailer 100 to be fully supported by the end member 142. The user can then position trailer 100 so that it is leaning against a wall surface 270.

The present invention may be embodied in other specific forms without departing from the spirit or essential attributes thereof, and it is, therefore, desired that the present embodiments be considered in all respects as illustrative and not restrictive.

1. A modular trailer comprising:
a trailer base frame including at least a pair of side members and a plurality of cross members, each side member including a series of end bores and each cross member including a series of top bores;
a tongue assembly coupled to said base frame;
at least one modular carrier assembly, the carrier assembly being removably couplable to said base frame and attachable to said attachment bores on the cross members; and
a telescoping end assembly including at least a pair of insertion members and an end member, each insertion member containing a series of insertion throughbores.

2. The modular trailer of claim 1 wherein each side member includes a hollow interior exposed at a rear end of said side members.

3. The modular trailer of claim 2 wherein each insertion member slidingly inserts into one of the hollow interiors such that at least one end bore on each side member and at least one insertion throughbore on each insertion member are alignable to define a continuous locking throughbore.

4. The modular trailer of claim 3 wherein an end fastener is inserted through at least one of the continuous locking throughbores, said end fastener adjustably fixing the length of the modular trailer.

5. The modular trailer of claim 1 wherein the modular carrier assembly comprises at least one locking channel and at least one support element.

6. The modular trailer of claim 5 wherein the support element is configured to support a vehicle selected from the group consisting of: Personal WaterCraft, All Terrain Vehicles, snowmobiles, motorcycles, golf carts and lawn and garden equipment.

7. The modular trailer of claim 5 wherein the support element is configured to support a utility bed.

8. The modular trailer of claim 5 wherein the locking channel includes a vertical member for selectively fixedly positioning the locking channel to the trailer base frame.

9. The modular trailer of claim 8 wherein the vertical member inserts into at least one of the attachment bores of the cross members.

10. The modular trailer of claim 9 wherein the vertical member is selected from the group consisting of: a welded projection, a pressed fitting, a spring loaded pin and a bolt fastener.

11. The modular trailer of claim 5 wherein the locking channel includes at least one pair of horizontal bores, the horizontal bores in vertical alignment to define at least one continuous mounting throughbore.

12. The modular trailer of claim 11 wherein a mounting fastener is slidably insertable into each of the at least one continuous mounting throughbores.

13. The modular trailer of claim 12 wherein the mounting fastener is selected from the group consisting of: a spring loaded pin connector, a screw type connector, a bracket, a retainer styled connector and an interference fit connector.

14. The modular trailer of claim 5 including at least two modular carrier assemblies.

15. The modular trailer of claim 14 wherein the at least two modular carrier assemblies are configured with different support elements.

16. The modular trailer of claim 15 wherein the at least two modular carrier assemblies are configured to support at least two different vehicles.

17. The modular trailer of claim 1 wherein the tongue assembly is removably couplable to the trailer base frame.

18. The modular trailer of claim 1 wherein a tire assembly is fixedly coupled to the trailer base frame.

19. A method for reducing a storage footprint for a modular trailer comprising:
removing a modular carrier assembly from a trailer base frame; and
slidably inserting a telescoping end assembly into the base frame until an end member of the end assembly is in contact with a pair of side members on the base frame; the telescoping end assembly being fully inserted when an end member of the end assembly comes into contact with the side members.

20. The method of claim 19 further comprising the step of lifting a front end of the trailer until the trailer is supported by the end assembly and the trailer is in a substantially vertical disposition.

21. The method of claim 20 further comprising the step of leaning the trailer against a wall surface.

22. The method of claim 19 further comprising removing a tongue assembly from the trailer base frame.

23. A method for changing a trailering configuration for a modular trailer comprising:
removing a first modular carrier from a trailer base frame, said first modular carrier including at least one first mounting channel having at least one first vertical member and at least one pair of opposing first horizontal throughbores defining at least one first locking throughbore, removal of said first modular carrier assembly requiring the removal of at least one horizontal fastener from the at least one first locking throughbore,
positioning a second modular carrier on the trailer base frame, said second modular carrier including at least one second mounting channel,
inserting at least one second vertical member on the second mounting channel into at least one top bore located on the trailer base frame; and
inserting the at least one horizontal fastener through a second locking throughbore defined by at least one pair of opposing second horizontal throughbores on the second mounting channel.

24. The method of claim 23 wherein the second modular carrier is configured to carry a vehicle selected from the group consisting of: Personal WaterCraft, All Terrain Vehicles, snowmobiles, motorcycles, golf carts and lawn and garden equipment.

25. The method of claim 23 wherein the second carrier assembly comprises a plurality of support elements.

26. The method of claim 25 wherein the plurality of support elements support a plurality of vehicles.

27. The method of claim 23 further comprising the step of adjusting a trailer length, said adjustment including adjustably sliding at least a pair of insertion members located on an end assembly into at least a pair of open ends on a pair of side members.

28. A modular carrier for use with a modular trailer comprising:
a vehicular support element, the support element including a mounting channel, a support member and a support connector;
wherein the mounting channel includes at least one vertical member, the at least one vertical member inserting into a top bore on a base frame of the trailer, the mounting channel including at least one pair of opposing throughbores, the support connector fully inserting through the at least one pair of opposing throughbores to attach to the base frame.

29. The modular carrier of claim 28 wherein the support element is configured to hold a vehicle selected from the group consisting of: Personal WaterCraft, All Terrain Vehicles, snowmobiles, motorcycles, bicycles, kayaks, canoes, golf carts and lawn and garden equipment.

30. The modular carrier assembly of claim 28 wherein the support member is selected from the group consisting of: rollers, bunks, textured floors, smooth floors, tracked floors and recessed floors.

31. A modular trailer comprising:
a trailer base frame including at least a pair of side members and at least a pair of cross members, each cross member including a series of attachment bores;
a tongue assembly coupled to said base frame; and
at least one modular carrier assembly, the carrier assembly being removably couplable to said cross members and attachable to said attachment bores on the cross members.

32. The modular trailer of claim 31 wherein the modular carrier assembly comprises at least one locking channel and at least one support element.

33. The modular trailer of claim 32 wherein the support element is configured to support a vehicle selected from the group consisting of: Personal WaterCraft, All Terrain Vehicles, snowmobiles, motorcycles, golf carts and lawn and garden equipment.

34. The modular trailer of claim 32 wherein the support element is configured to support a utility bed.

35. The modular trailer of claim 32 wherein the locking channel includes a vertical member for selectively fixedly positioning the locking channel to the base frame.

36. The modular trailer of claim 35 wherein the vertical member inserts into at least one of the attachment bores of the cross members.

37. The modular trailer of claim 36 wherein the vertical member is selected from the group consisting of: a welded projection, a pressed fitting, a spring loaded pin and a bolt fastener.

38. The modular trailer of claim 32 wherein the locking channel includes at least one pair of horizontal bores, the horizontal bores in vertical alignment to define at least one continuous mounting throughbore.

39. The modular trailer of claim 38 wherein a mounting fastener is slidably insertable into each of the at least one continuous mounting throughbores.

40. The modular trailer of claim 39 wherein the mounting fastener is selected from the group consisting of: a spring loaded pin connector, a screw type connector, a bracket, a retainer styled connector and an interference fit connector.

41. The modular trailer of claim 31 including at least two modular carrier assemblies.

42. The modular trailer of claim 41 wherein the at least two modular carrier assemblies are configured with different support elements.

43. The modular trailer of claim 42 wherein the at least two modular carrier assemblies are configured to support at least two different vehicles.

44. The modular trailer of claim 31 wherein the tongue assembly is removably couplable to the trailer base frame.

45. The modular trailer of claim 31 wherein a tire assembly is fixedly coupled to the trailer base frame.
